(19) United States
(12) Patent Application Publication
(10) Pub. No.: US 2023/0182490 A1
(43) Pub. Date: Jun. 15, 2023

(54) ADHESIVE SURFACES FOR PRINTING DEVICES

(71) Applicant: Hewlett-Packard Development Company, L.P., Spring, TX (US)

(72) Inventors: Raimon CASTELLS DE MONET, Sant Cugat del Valles (ES); Oriol MARTINEZ RIBA, Sant Cugat del Valles (ES); Pedro Luis LAS HERAS SANZ, Sant Cugat del Valles (ES); Marco Ignacio BARBETTA, Sant Cugat del Valles (ES)

(73) Assignee: Hewlett-Packard Development Company, L.P., Spring, TX (US)

(21) Appl. No.: 17/999,353

(22) PCT Filed: May 21, 2020
(86) PCT No.: PCT/US2020/033991

§ 371 Date: Nov. 18, 2022

(51) Int. Cl. B41J 11/00

(52) U.S. Cl. CPC B41J 11/007; B41J 11/001

(57) ABSTRACT

Disclosed herein is an adhesive belt for use in a printing device, a printing device, and a method of operating a printing device. The adhesive belt is to be placed around a conveyer belt of a printing device. The adhesive belt comprises a contact surface that is to come in contact with a print medium, wherein the contact surface comprises a dry adhesive material. The adhesive belt further comprises a fastener that is to open and close the adhesive belt by reversibly joining opposing end portions of the adhesive belt.

### BACKGROUND

A printing device like an ink-jet printer may be used to print on a variety of different print media, including stretchable substrates such as textiles. The print medium may be placed on a supporting structure such as a conveyer belt in the printing device, e.g. for transporting the print medium through a print zone of the printing device and for supporting the print medium during the printing process.

### BRIEF DESCRIPTION OF DRAWINGS

In the following, a detailed description of various examples is given with reference to the figures. The figures show schematic illustrations of

FIG. 1a: an adhesive belt according to an example in side view;

FIG. 1b: the adhesive belt of FIG. 1a in top view in accordance with an example;

FIG. 2a: a contact surface with synthetic setae according to an example in a cross-sectional side view;

FIG. 2b: a contact surface with microscopic suction cups according to an example in a cross-sectional side view;

FIG. 3: an adhesive belt placed around a conveyer belt in accordance with an example in a cross-sectional side view;

FIG. 4a: a printing device according to an example in a first side view;

FIG. 4b: the printing device of FIG. 4a in a second side view in accordance with an example;

FIG. 5a: a supporting structure of a media handling system in a printing device comprising an adhesive board according to an example;

FIG. 5b: a supporting structure of a media handling system in a printing device comprising an adhesive board with an edge holder in accordance with an example; and

FIG. 6: a method of operating a printing device according to an example.

### DETAILED DESCRIPTION

Stretchable substrates such as textiles may be challenging to print on. Their shape may be modified even as a result of small forces, which may result in image quality defects such as blurred images or misaligned patches. Furthermore, stretchable substrates may form curls at their edges. These curls may come in contact with parts of a printing device such as a print head, which may cause the substrate to become stuck in the printing device. To avoid such issues, a transport belt that is used to advance the substrate may for example be coated with a glue to fix the substrate and its edges on the transport belt. However, the glue may have to be cleaned and exchanged on a regular basis, which may be a labor- and resource-intensive process. Moreover, the substrate may become contaminated with glue remaining thereon after removing the substrate from the transport belt.

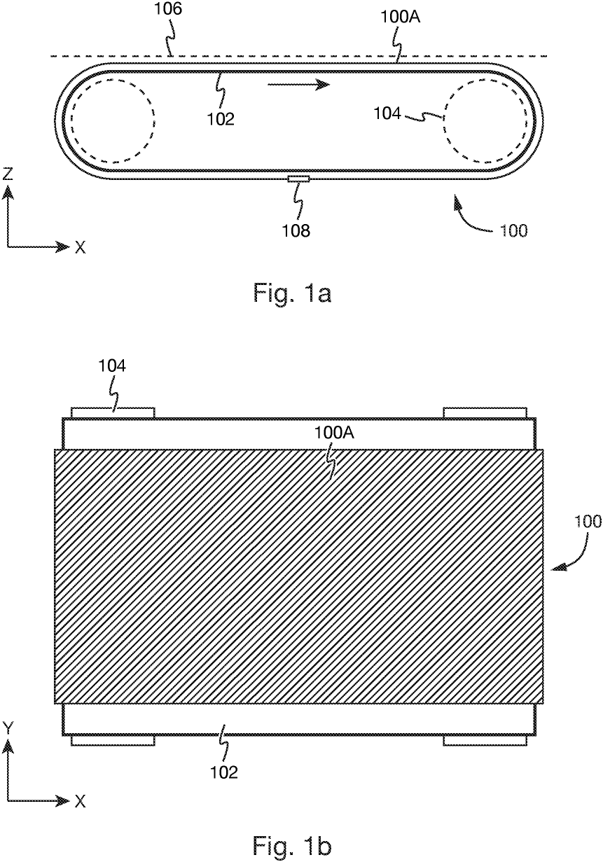

FIGS. 1a and 1b depict schematic illustrations of an adhesive belt 100 for use in a printing device (not shown) in accordance with an example. The adhesive belt 100 is shown in side view in FIG. 1a and in top view in FIG. 1b.

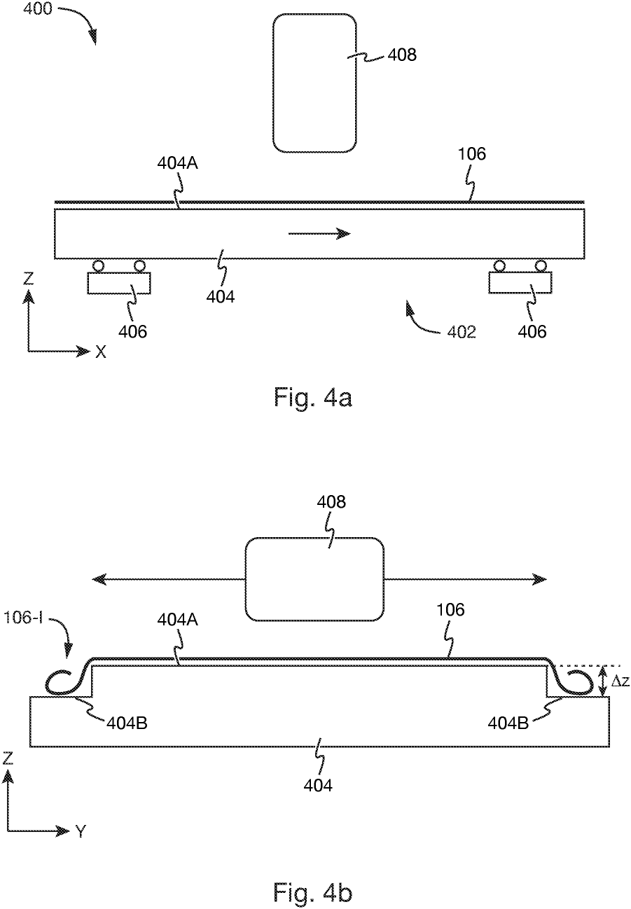

The adhesive belt 100 is to be placed around a conveyer belt 102 of a printing device, e.g. such that the adhesive belt 100 extends along the circumference of the conveyer belt 102 as shown in FIG. 1a. The conveyer belt 102 may for example be arranged on two or more pulleys 104 in the printing device, which may e.g. be driven by an actuator such as an electric motor to move the conveyer belt 102. The conveyer belt 102 may be part of a media handling system of the printing device, which may e.g. be to support and advance a print medium 106 through a print zone of the printing device, for example as detailed below with reference to FIGS. 4a and 4b.

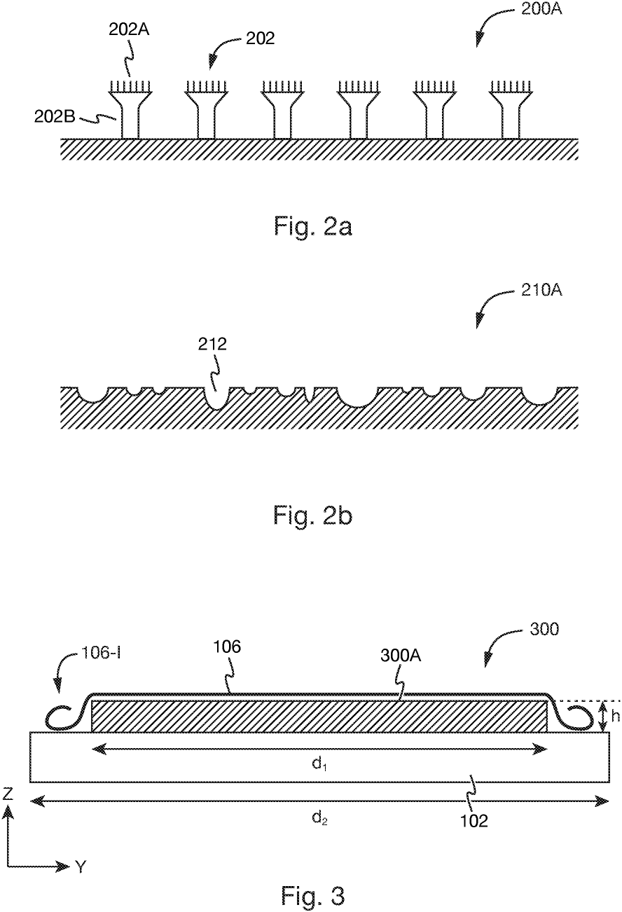

The adhesive belt 100 comprises a contact surface 100A that is to come in contact with the print medium 106. The adhesive belt 100 may for example be placed around the conveyer belt 102 such that the contact surface 100A faces outwards, i.e. away from an outer surface of the conveyer belt 102, and the print medium 106 can be placed thereon. The contact surface 100A comprises a dry adhesive material that is to fix the print medium 106 on the contact surface 100A, e.g. to prevent the print medium 106 from moving on or detaching from the contact surface 100A during printing. The dry adhesive material is to adhere to the print medium 106 without an adhesive substance such as glue applied thereon. The dry adhesive material may be a solid material, i.e. may not flow or exhibit viscosity. The dry adhesive material may be to maintain its general structure when coming in contact with the print medium 106 and may be to return to its initial or intrinsic shape when the print medium 106 is removed from the contact surface 100A. In other words, there is always a well-defined border or interface between the contact surface 100A and the print medium 106. The dry adhesive material may be to adhere to the print medium 106 without the dry adhesive material wetting the print medium 106 and without forming chemical bonds between the contact surface 100A and the print medium 106. The dry adhesive material may for example be to adhere to the print medium 106 by dispersive adhesion, e.g. through van-der-Waals forces between the contact surface 100A and the print medium 106. In some examples, the dry adhesive material may have been structured microscopically on its surface. The dry adhesive material may for example comprise a plurality of microscopic adhesive structures on the contact surface 100A that are to adhere to the print medium 106, e.g. as detailed below with reference to FIGS. 2a and 2b. The dry adhesive material may for example be to generate a stiction force parallel to the contact surface 100A of up to 0.1 N per cm², in some examples of up to 1 N per cm², in one example of up to 10 N per cm² and in one example of up to 40 N per cm², wherein the stiction force is the force that has to be overcome in order to move or slide the print medium 106 on the contact surface 100A. Another way of describing the stiction force may be the force characterizing the shear strength of the connection between the dry adhesive material and the print medium 106. The dry adhesive material may extend over the entire contact surface 100A or a part thereof. The dry adhesive material may for example cover between 50% and 100%, in one example between 80% and 100% of the surface area of the contact surface 100A.

The adhesive belt 100 further comprises a fastener 108 that is to open and close the adhesive belt 100 by reversibly joining opposing end portions of the adhesive belt 100. This may allow for adding or removing the adhesive belt 100 depending on the type of substrate to be used with the printing device, e.g. to place the adhesive belt 100 around the conveyer belt 102 for printing on a stretchable substrate such as a textile and to remove the adhesive belt 100 for printing on a non-stretchable substrate such as paper, cardboard, wood, plastic, or metal. The fastener 108 may for example comprise a zipper, which may e.g. be arranged on edges of the respective end portions to reversibly join the edges. In other examples, the fastener 108 may e.g. comprise a hook on one of the end portions of the adhesive belt 100 that may be inserted into a corresponding opening of the opposing end portion, which may for example be formed by a ring-shaped structure attached to an edge of opposing end portion. In yet another example, the fastener 108 may comprise a plurality of interleaving ring-shaped structures attached to edges of the opposing end portions and a connecting element such as a wire or thread that is to be threaded through the ring-shaped structures to join the opposing end portions. The ring-shaped structures may for example be arranged on the edges of the opposing end portions such that a ring-shaped structure on one of the end portions is arranged between respective two of the ring-shaped structures on the opposing end portion when the end portions are joined, thereby forming an alternating arrangement of ring-shaped structures of the two end portions. Openings of the ring-shaped structures may e.g. be perpendicular to the respective edge such that the interleaving ring-shaped structures form a tubelike assembly in which the connecting element can be arranged. Additionally or alternatively, the fastener 108 may e.g. also comprise a hook-and-loop or Velcro strip, a magnet, or a solvable adhesive.

In some examples, an inner circumference of the adhesive belt 100 when removed from the conveyer belt 102 may be smaller than an outer circumference of the conveyer belt 102, e.g. such that the adhesive belt 100 has to be stretched slightly to be placed around the conveyer belt 102. This may ensure a tight fit of the adhesive belt 100 on the conveyer belt 102, e.g. such that the adhesive belt 100 is fixed relative to the conveyer belt 102 and can be moved by moving the conveyer belt 102. The inner circumference of the adhesive belt 100 may for example be between 95% and 100% of the outer circumference of the conveyer belt 102, e.g. between 95% and 99.5%, in one example between 98% and 99.5% of the outer circumference of the conveyer belt 102 . Additionally or alternatively, the adhesive belt 100 may be attached to the conveyer belt 102 by other means, e.g. glued to the conveyer belt 102 or fixed to the conveyor belt 102 through a clipping pin or a clamp.

FIGS. 2a and 2b depict contact surfaces 200A and 210A, respectively, of an adhesive belt such as the adhesive belt 100 according to two examples. The contact surface 100A of the adhesive belt 100 may e.g. be designed in a similar way or equal to one of the contact surfaces 200A, 210A or a combination thereof. In both examples, the dry adhesive material is formed by microscopic structuring of the contact surface 200A, 210A, e.g. by etching, photolithography, electron-beam lithography, or a combination thereof. The resulting microscopic adhesive structures are to adhere to the print medium 106, e.g. through van-der-Waals forces at contact points between the microscopic adhesive structures and the print medium 106.

In some examples, the adhesive belt 100 may comprise two or more layers, e.g. a main layer and a microscopically structured coating or tape arranged thereon, which forms the contact surface 100A, 200A, 210A or a part thereof. The main layer may comprise a flexible or elastic material, including e.g. silicone or rubber and may e.g. have a thickness between 3.5 mm and 20 mm, in one example between 7.5 mm and 15 mm. The coating or tape may e.g. comprise a polymer material such as polyethylene terephthalate (PET), thermoplastic polyurethane (TPU), polypropylene or polyimide. Additionally or alternatively, the coating or tape may comprise carbon-based nanostructures, e.g. carbon nanotubes. A thickness of the coating or tape may for example be between 20 µm and 2 mm, in one example between 200 µm and 2 mm.

In the example of FIG. 2a, the contact surface 200A comprises a dry adhesive material having a plurality of synthetic setae 202 on its surface. The synthetic setae 202 are microscopic adhesive structures that are inspired by the structures found on the feet of geckos. A synthetic seta 202 comprises a plurality of spatula-like nanoscale structures 202A, also referred to as spatulae. A synthetic seta 202 may for example comprise between 10 and 1000 spatulae, wherein each spatula 202A may e.g. have a diameter between 50 nm and 500 nm. The spatulae 202A may for example be arranged on a microscopic protrusion such as a hair-like microfiber 202B extending from the contact surface 200A as illustrated in FIG. 2a, wherein each microfiber 202B may e.g. have a diameter between 2 µm and 50 µm. In other examples, the spatulae 202A may be arranged on a flat surface instead, e.g. directly on the contact surface 200A. The density of synthetic setae on the contact surface 200A may for example be between 100 and 10000 setae per mm². The synthetic setae 202 may be arranged on the contact surface 200A in a periodic or aperiodic pattern.

In the example of FIG. 2b, the contact surface 210A comprises a dry adhesive material having a plurality of microscopic suction cups 212. The suction cups 212 may for example be recesses or depressions in the contact surface 210A. A diameter or width of the suction cups 212 parallel to the contact surface 210A may e.g. be between 1 µm and 200 µm, in one example between 10 µm and 70 µm. In some examples, the diameter or width of the suction cups 212 may be smaller than an average width of fibers in the print medium 106 or smaller than an average size of surface features such as protrusions or irregularities on a surface of the print medium 106. A depth of the suction cups 212 perpendicular to the contact surface 210A may e.g. be between 1 µm and 200 µm. In some examples, the contact surface 210A may comprise suction cups 212 of different sizes as illustrated in FIG. 3. In other examples, the size of the suction cups 212 may be the same throughout the contact surface 210A. The suction cups 202 may be arranged on the contact surface 210A in a periodic or aperiodic pattern. In some examples, the contact surface 210A may additionally comprise other microscopic adhesive structures, e.g. synthetic setae 202 similar to the contact surface 200A.

FIG. 3 depicts a schematic cross-sectional view of an adhesive belt 300 placed around a conveyer belt 102 of a printing device (not shown) in accordance with an example. The adhesive belt 300 may for example be similar to the adhesive belt 100 of FIGS. 1a, 1b and also comprises a contact surface 300A that is to come in contact with a print medium 106 as well as a fastener (not shown) for reversibly opening and closing the adhesive belt 300. The cross-section of FIG. 3 may for example correspond to a cut along the Y axis of FIG. 1b.

The adhesive belt 300 has a thickness h perpendicular to the contact surface 300A that is between 4 mm and 20 mm, in one example between 7.5 mm and 15 mm. A width d₁ of the adhesive belt 300 parallel to the contact surface 300A and perpendicular to the circumference of the adhesive belt 300 may be smaller than a width d₂ of the conveyer belt 102 that the adhesive belt 300 is to be placed around. The width d₁, in different examples, may be between 5 cm and 50 cm or between 50 cm and 200 cm smaller than the width d₂. The width d₁ of the adhesive belt 300 may be adapted to a width of the print medium 106, e.g. such that the width d₁ is smaller than the width of the print medium 106, for example between 2 cm and 10 cm smaller than the width of the print medium 106.

The smaller width of the adhesive belt 300 may allow for accommodating lateral edge portions 106-I of the print medium 106 on the conveyer belt 102. If the print medium 106 is stretchable, curls may form in the edge portions 106-I as illustrated in FIG. 3. Additionally or alternatively, other edge defects may be present in the edge portions 106-I of the print medium 106, e.g. lint, cross wrinkles, protrusions, or melt residues, which may for example result from processing of the print medium 106, e.g. from cutting the print medium 106. The smaller width of the adhesive belt 300 may allow for accommodating the curls and other edge defects on the conveyer belt 102 adjacent to edges of the adhesive belt 300, e.g. such that the curls lie lower than an upper surface of the print medium 106 on the adhesive belt 300, in some examples lower than an upper surface of the adhesive belt 300 itself as shown in FIG. 3. This may prevent the curls and other edge defects from interfering with other parts of the printing device without using glue to attach the edges of the print medium 106 to the conveyer belt 102.

FIGS. 4a and 4b depict a schematic illustration of a printing device 400 according to an example, wherein FIG. 4a shows the printing device 400 in a first side view, e.g. along the Y axis of FIG. 4b, and FIG. 4b shows the printing device 400 in a second side view, e.g. along the X axis of FIG. 4a. The printing device 400 may be to deposit a printing fluid such as ink on a print medium 106, e.g. a rigid print medium such as cardboard, wood, plastic, and metal or a flexible print medium such as paper or textile. In some examples, the printing device 400 may be to print on both rigid and flexible print media. The printing device 400 may for example be an ink-jet printer, e.g. a large-format latex printer. To deposit the printing fluid, the printing device 400 may comprise a printing unit 408, which may e.g. be a moveable print head that can be received in a one-axis or two-axes carriage and moved across a print zone as illustrated in FIG. 4b or a stationary page wide print bar (not shown) that extends across the entire print zone.

The printing device 400 comprises a media handling system 402 that is to handle the print medium 106 in the printing device 400. The media handling system 402 may for example be to advance the print medium 106 in the printing device 400 along a media advance direction, which may e.g. be parallel to the X axis of FIG. 4a. The media handling system 402 may for example be to receive a sheet substrate and to advance the sheet substrate through the print zone of the printing device 400. Additionally or alternatively, the media handling system 402 may be to receive a roll substrate, e.g. a long textile web that is rolled up on a supply roll, and to sequentially advance the roll substrate through the print zone, e.g. by unrolling the textile web from the supply roll in front of the print zone and reeling the textile web up on an output roll behind the print zone. In other examples, the printing device 400 may be a flatbed printer, wherein the media handling system 402 is to hold the print medium 106 without advancing the print medium 106, e.g. while the printing unit 408 may move in one or two directions across the print medium 106 to deposit the printing fluid.

The media handling system 402 comprises a supporting structure 404 that is to support the print medium 106, for example by placing the print medium 106 on the supporting structure 404 as illustrated in FIGS. 4a, 4b. The media handling system 402 may further comprise an actuator 406 such as an electric motor that is to advance the supporting structure 404 with the print medium 106 arranged thereon in the media advance direction, e.g. via a pulley or a drive roll in contact with the supporting structure 404. In other examples, the media handling system 402 may not be to move the supporting structure 404. The supporting structure 404 may be e.g. be a fixed structure within the printing device 400 or may e.g. be placed or mounted in the printing device 400 by a user.

The supporting structure 404 comprises an adhesion surface 404A that is to adhere to the print medium 106 on the supporting structure 404. The adhesion surface 404A may for example be similar to one of the contact surfaces 100A, 200A, 210A, 300A described above. In some examples, the adhesion surface 404A may be microscopically structured to enhance adhesion between the adhesion surface 404A and the print medium 106, e.g. similar to the contact surfaces 200A, 210A.

The supporting structure 404 further comprises a supporting surface 404B adjacent to an edge of the adhesion surface 404A. The supporting surface 404B is offset from the adhesion surface 404A in a direction perpendicular to the adhesion surface 404A, e.g. by a distance Δz as illustrated in FIG. 4b. The supporting surface 404B is to support an edge portion 106-I of the print medium 106 on the supporting structure 404. In some examples, the supporting structure 404 may comprise two supporting surfaces 404B adjacent to opposing edges of the adhesion surface 404A, e.g. as shown in FIG. 4b. The distance Δz may be chosen such that edge defects such as curls forming in the edge portion 106-I may be placed on the supporting surface 404B without protruding above an upper surface of the print medium 106 on the adhesion surface 404A, in some examples without protruding above an upper surface of the adhesion surface 404A itself, e.g. similar to the adhesive belt 300 described above. The distance Δz may for example be between 4 mm and 20 mm, in one example between 7.5 mm and 15 mm. A width of the supporting surface 404B perpendicular to the media advance direction of the printing device 400 may for example be between 2.5 cm and 25 cm, in one example between 25 cm and 100 cm. In one example, a width of the print medium 106 may e.g. be about 36 inch and a width of the adhesion surface 404A may e.g. be about 34 inch. The printer width may for example be up to 250 cm, e.g. about 98 inch, wherein the printer width may for example correspond to the combined width of the adhesion surface 404A and two supporting surfaces 404B adjacent to opposing edges of the adhesion surface 404A as illustrated in FIG. 4b.

In some examples, the media handling system 402 may be to move the entire supporting structure 404 in order to advance the print medium 106, e.g. using the actuator 406. In other examples, the media handling system 402 may be to move the adhesion surface 404A, whereas the supporting surface 404B be a fixed surface in the printing device that is not moved.

In some examples, the media handling system 402 may comprise a transport belt that is to support and advance the print medium 106. The supporting surface 404B may be a surface of the transport belt, i.e. the transport belt may form at least a part of the supporting structure 404. In some examples, the adhesion surface 404A may also be a surface of the transport belt, i.e. both the adhesion surface 404A and the supporting surface 404B of the supporting structure 404 may be formed by the transport belt. The transport belt may for example have a protruding center portion comprising a dry adhesive material, e.g. as illustrated in FIG. 4b, wherein the protruding center portion extends along the circumference of the transport belt or at least a part thereof.

In other examples, the transport belt may e.g. be similar to the conveyer belt 102 of FIGS. 1a, 1b. The media handling system 402 may further comprise an accessory belt that is to be removably placed around the transport belt, wherein the accessory belt may e.g. be similar to one of the adhesive belts 100 and 300 described above. In some examples, the accessory belt may be similar to one of the adhesive belts 100 and 300, but may be a closed belt without a fastener. The accessory belt may e.g. comprise an elastic material, which may be stretched to place the accessory belt around the transport belt. The supporting surface 404B may be a surface of the transport belt, whereas the adhesion surface 404A may be a surface of the accessory belt, e.g. the contact surface 100A, 300A of one of the adhesive belts 100 and 300. A width of the accessory belt may be smaller than a width of the transport belt such that the supporting surface 404B on the transport belt is not covered by the accessory belt when placed around the transport belt, e.g. as shown in FIG. 3.

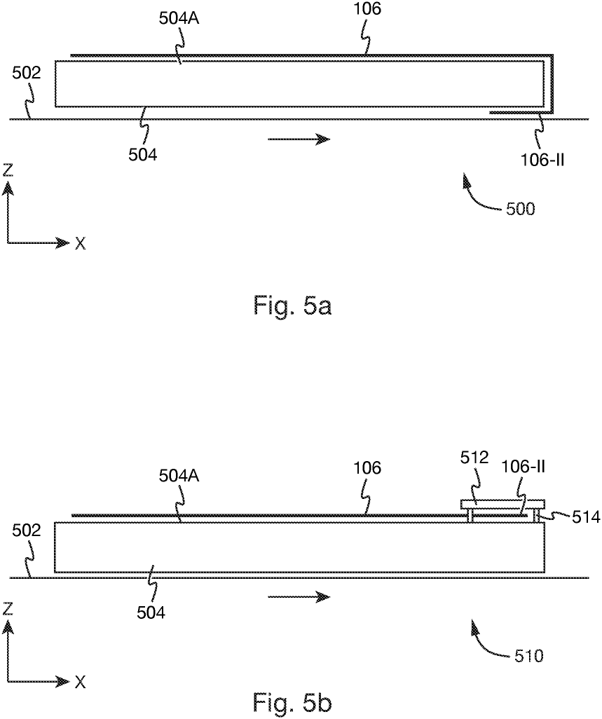

FIG. 5a depicts a schematic illustration of a supporting structure 500 of a media handling system in a printing device (not shown) in accordance with another example. The supporting structure 500 may for example be employed in a printing device such as the printing device 400, e.g. as part of the media handling system 402. In the example of FIG. 5a, the supporting structure 500 comprises a transport belt 502, which may e.g. be similar to the conveyer belt 102 in FIGS. 1a, 1b. The supporting structure 500 further comprises an adhesive board 504 with an adhesion surface 504A that the print medium 106, e.g. a sheet substrate, is to be placed on. The adhesion surface 504A is to adhere to the print medium 106 and may e.g. comprise a dry adhesive material, for example a plurality of microscopic adhesive structures. The adhesive board 504 may be separate from the transport belt 502 and may e.g. be placed on the transport belt 502 to advance the print medium 106 in the printing device. A width of the adhesive board 504 may be smaller than a width of the transport belt 502 perpendicular to the media advance direction, e.g. such that uncovered portions of the outer surface of the transport belt 502 adjacent to lateral edges of the adhesive board 504 form the supporting surface similar to FIGS. 3 and 4b.

In some examples, the supporting structure 500 may not comprise the conveyer belt 102, but the adhesive board 504 may e.g. be placed on a plurality of drive rolls similar to the supporting structure 404 of FIG. 4a or may be part of a media handling system of a flatbed printer, which may e.g. be to receive the adhesive board 504 and hold the adhesive board 504 in place without moving the adhesive board 504. In one example, the adhesive board 504 may e.g. comprise a protruding center portion with a dry adhesive material forming the adhesion surface and offset edge portions adjacent to edges of the protruding center portion forming the supporting surface, e.g. similar to the supporting structure 404 in FIG. 4b.

In some examples, a leading edge portion 106-II of the print medium 106, i.e. the edge portion of the print medium 106 facing in the media advance direction, may be fixed to the supporting structure 500. For example, the leading edge portion 106-II may be placed between the adhesive board 504 and the transport belt 502 such that the weight of the adhesive board 504 fixes the leading edge portion 106-II, e.g. to prevent the leading edge portion 106-II from curling up or interfering with other parts of the printing device. In other examples, the adhesive board 504 may comprise a strip of glue (not shown) to glue the leading edge portion 106-II to the adhesive board 504.

FIG. 5b depicts a schematic illustration of a supporting structure 510 of a media handling system in a printing device (not shown) in accordance with another example. The supporting structure 510 is similar to the supporting structure 500 of FIG. 5a. In addition, the supporting structure 510 comprises an edge holder that is to fix the leading edge portion 106-II of the print medium 106 to the supporting structure 510. The edge holder may for example comprise a top plate 512 that is attached to or pressed against the adhesive board 504, e.g. via clips or fasteners 514, wherein the leading edge portion 106-II may be arranged between the top plate 512 and the adhesive board 504, e.g. to clamp the leading edge portion 106-II therebetween.

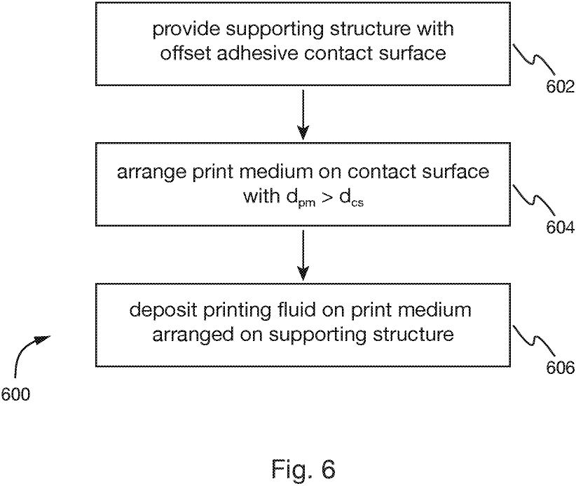

FIG. 6 shows a flow chart of a method 600 of operating a printing device according to an example. The method 600 may for example be executed with a printing device in accordance with one of the examples described herein, e.g. with the printing device 400. The method 600 may also be executed with another printing device using an adhesive belt according to one of the examples described herein, e.g. the adhesive belt 100. In the following, the printing device 400 and the adhesive belt 100 will be used as illustrative examples. This is, however, not intended to be limiting in any way and the method 600 may also be executed with another printing device, e.g. a printing device comprising one of the supporting structures 500 and 510, and/or with another adhesive belt such as the adhesive belt 300. Furthermore, the method 600 is not limited to the order of execution indicated by the flow chart of FIG. 6. As far as technically feasible, the method 600 may be executed in an arbitrary order and parts thereof may be executed simultaneously at least in part.

The method 600 comprises, in block 602, providing a supporting structure for a print medium. The supporting structure has a contact surface that is offset from the supporting structure. The contact surface may for example be a surface of an element or structure that protrudes from surrounding portions of the supporting structure. The contact surface comprises a dry adhesive material, which may e.g. comprise a plurality of microscopic adhesive structures as detailed above. The supporting structure may for example be provided as part of the printing device 400. Accordingly, the supporting structure may e.g. be the supporting structure 402 with the adhesion surface 404A corresponding to the contact surface.

In some examples, the contact surface may be a surface of an adhesive belt such as the contact surface 100A of the adhesive belt 100. Accordingly, providing the supporting structure may comprise providing an adhesive belt, e.g. the adhesive belt 100. In some examples, this may comprise placing the adhesive belt 100 around a conveyer belt 102 of the printing device, e.g. as shown in FIGS. 1a, 1b. In one example, this may comprise permanently placing the adhesive belt 100 around the conveyer belt 102, e.g. by gluing the adhesive belt 100 onto the conveyer belt 102. In another example, the adhesive belt 100 may be placed around the conveyer belt 102 in a reversible fashion, e.g. as described above with reference to FIGS. 1a, 1b. Accordingly, placing the adhesive belt 100 around the conveyer belt 102 may comprise closing a fastener 108 of the adhesive belt 100 to reversibly join opposing end portions of the adhesive belt 100.

The method 600 further comprises, in block 604, arranging a print medium on the contact surface of the supporting structure, e.g. by arranging the print medium 106 on the adhesion surface 404A of the supporting structure 404 of the printing device 400 or by arranging the print medium 106 on the contact surface 100A of the adhesive belt 100. The print medium 106 may for example comprise a stretchable material, e.g. a stretchable textile. In some examples, the print medium 106 may be supplied on a supply roll and may be arranged on the contact surface by unrolling the print medium 106 from the supply roll.

In other examples, the print medium 106 may be supplied as a sheet substrate and may be arranged on the contact surface by placing the sheet substrate on the supporting structure, e.g. by placing the sheet substrate on a transport belt. In some examples, this may comprise placing the print medium 106 on an adhesive board such as the adhesive board 504, e.g. prior to supplying the print medium 106 to the printing device 400. Arranging the print medium on the contact surface may further comprise fixing a leading edge portion 106-II of the print medium 106 to the supporting structure. This may for example comprise placing the leading edge portion 106-II between the adhesive board 504 and the transport belt 502 as shown in FIG. 5a, attaching the leading edge portion 106-II to a stripe of glue on the supporting structure, e.g. to a stripe of glue on the adhesive board 504, or clamping the leading edge portion 106-II to the supporting structure using an edge holder, e.g. by clamping the leading edge portion 106-II to the adhesive board 504 as shown in FIG. 5b.

A width dₚₘ of the print medium is larger than a width of the contact surface d_{cs}. The width of the print medium 106 may for example be larger than the width of the adhesion surface 404A of the supporting structure 404 or larger than the width d₁ of the adhesive belt 100. The width may e.g. be measured perpendicular to a media advance direction for the print medium 106. In one example, the width dₚₘ of the print medium is between 2 cm and 10 cm larger than a width of the contact surface d_{cs}.

In some examples, arranging the print medium on the contact surface comprises arranging an edge portion of the print medium on the supporting structure adjacent to an edge of the contact surface. The edge portion may e.g. be arranged on the supporting structure such that the edge portion of the print medium is lower than a top surface of the print medium on the contact surface, in some examples lower than the contact surface itself. For example, the print medium 106 may be arranged on the adhesion surface 404A such that the lateral edge portion 106-I is arranged on the supporting surface 404B, e.g. as illustrated in FIG. 4b. In another example, the print medium 106 may be arranged on the contact surface 100A of the adhesive belt 100 such that the lateral edge portion 106-I is arranged on the conveyer belt 102 adjacent to an edge of the contact surface 100A, e.g. similar to the example of FIG. 3.

The method 600 further comprises, at block 606, depositing a printing fluid on the print medium arranged on the supporting structure. The printing fluid may for example be ink and may e.g. be deposited using the printing unit 408. In some examples, depositing the printing fluid may comprise advancing the print medium arranged on the supporting structure through a print zone of the printing device. This may e.g. comprise moving the conveyer belt 102 and thereby the adhesive belt 100 by rotating the pulley 104. In other examples, this may comprise moving the supporting structure 404, e.g. by using the actuator 406 to rotate a drive roll or a pulley in contact with the supporting structure 404. In one example, this may comprise moving an adhesive board such as the adhesive board 504 in FIGS. 5a, 5b, e.g. by moving the transport belt 502 that the adhesive board 504 is placed on or by rotating a drive roll that the adhesive board 504 is in contact with. Additionally or alternatively, depositing the printing fluid may also comprise moving the printing unit 408 across the print medium 106 arranged on the supporting structure 404, wherein the printing unit 408 may e.g. be a print head. In some examples, depositing the printing fluid on the print medium arranged on the supporting structure may not comprise advancing the print medium, e.g. in a flatbed printer. A print head may be provided in a one-axis or two-axis carriage to move across the print zone. The print head alternatively may comprise a stationary or movable page wide print bar which extends across a width of the print zone.

The description is not intended to be exhaustive or limiting to any of the examples described above. The adhesive belt, the printing device and the method of operating a printing device disclosed herein can be implemented in various ways and with many modifications without altering the underlying basic properties.

1. An adhesive belt for use in a printing device, wherein the adhesive belt is to be placed around a conveyer belt of the printing device, the adhesive belt comprising:
a contact surface that is to come in contact with a print medium, wherein the contact surface comprises a dry adhesive material; and
a fastener that is to open and close the adhesive belt by reversibly joining opposing end portions of the adhesive belt.

2. The adhesive belt of claim 1, wherein the dry adhesive material comprises a plurality of microscopic adhesive structures that are to adhere to the print medium.

3. The adhesive belt of claim 2, wherein the microscopic adhesive structures comprise microscopic suction cups having a diameter between 1 µm and 200 µm.

4. The adhesive belt of claim 1, wherein the fastener comprises a zipper, a hook-opening structure, interleaving ring-shaped structures and a connecting element, a hook-and-loop or Velcro strip, a magnet, or a solvable adhesive.

5. The adhesive belt of claim 1, wherein a thickness of the adhesive belt perpendicular to the contact surface is between 4 mm and 20 mm.

6. A printing device comprising a media handling system for handling a print medium in the printing device, the media handling system comprising a supporting structure for supporting the print medium, wherein the supporting structure comprises:
an adhesion surface that is to adhere to the print medium on the supporting structure; and
a supporting surface adjacent to an edge of the adhesion surface, wherein the supporting surface is offset from the adhesion surface in a direction perpendicular to the adhesion surface and is to support an edge portion of the print medium on the supporting structure.

7. The printing device of claim 6, wherein the adhesion surface is microscopically structured to enhance adhesion between the adhesion surface and the print medium.

8. The printing device of claim 6, wherein the media handling system comprises a transport belt for advancing the print medium and the supporting surface is a surface of the transport belt.

9. The printing device of claim 8, wherein the media handling system comprises an accessory belt that is to be reversibly placed around the transport belt, wherein the adhesion surface is a surface of the accessory belt and a width of the accessory belt is smaller than a width of the transport belt.

10. A method of operating a printing device, the method comprising:
providing a supporting structure for a print medium, the supporting structure having a contact surface that is offset from the supporting structure and comprises a dry adhesive material;
arranging a print medium on the contact surface of the supporting structure, wherein a width of the print medium is larger than a width of the contact surface; and
depositing a printing fluid on the print medium arranged on the supporting structure.

11. The method of claim 10, wherein arranging the print medium on the contact surface comprises arranging an edge portion of the print medium on the supporting structure adjacent to an edge of the contact surface such that the edge portion of the print medium is lower than a top surface of the print medium on the contact surface.

12. The method of claim 10, wherein the print medium is a sheet substrate and arranging the print medium on the contact surface comprises fixing a leading edge portion of the sheet substrate to the supporting structure.

13. The method of claim 10, wherein the contact surface is a surface of an adhesive belt and providing the supporting structure comprises placing the adhesive belt around a conveyer belt of the printing device.

14. The method of claim 13, wherein placing the adhesive belt around the conveyer belt comprises closing a fastener of the adhesive belt to reversibly join opposing end portions of the adhesive belt.

15. The method of claim 14, wherein the print medium comprises a stretchable material.
